(19) United States
(12) Patent Application Publication
(10) Pub. No.: US 2025/0358686 A1
(43) Pub. Date: Nov. 20, 2025

(54) DEVICE AND METHOD FOR CONFIGURING A RADIO SUBNETWORK

(71) Applicant: Robert Bosch GmbH, Stuttgart (DE)

(72) Inventors: Liliana Elizabeth Zarco Barragan, Stuttgart (DE); David Osamu Ginthoer, Stuttgart (DE); Oleg Schell, Krautheim (DE)

(21) Appl. No.: 19/210,332

(22) Filed: May 16, 2025

(30) Foreign Application Priority Data
May 17, 2024 (DE) 10 2024 204 611.6

(51) Int. Cl. H04W 28/24; H04W 16/30; H04W 28/18

(52) U.S. Cl. CPC H04W 28/24; H04W 16/30; H04W 28/18

(57) ABSTRACT

A device and a method for configuring a radio subnetwork of radio subnetworks provided by entities, wherein the method comprises determining a configuration of the radio subnetwork, wherein the configuration comprises features of the radio subnetwork, determining at least one requirement of at least one of the radio subnetworks, determining body shapes for the entities depending on at least one feature, wherein the at least one feature is selected from the configuration depending on the at least one requirement, determining a configuration of the radio subnetwork depending on an intersection of at least two of the body shapes, wherein the configuration of the radio subnetwork comprises features of the radio subnetwork, configuring the radio subnetwork according to the configuration of the radio subnetwork.

### BACKGROUND

The invention relates to a device and a method for configuring a radio subnetwork.

Efficient planning, controlling and monitoring of a feature configuration of the radio subnetwork is key to configuring the radio subnetwork in highly complex environment.

### SUMMARY

The method and device for configuring a radio subnetwork according to the disclosure provides efficient planning, controlling and monitoring of a feature configuration of the radio subnetwork.

The method for configuring a radio subnetwork of radio subnetworks provided by entities comprises determining a configuration of radio subnetworks, wherein the configuration comprises features of the radio subnetworks, determining at least one requirement of at least one of the radio subnetworks, determining body shapes for the entities depending on at least one feature, wherein the at least one feature is selected from the configuration depending on the at least one requirement, determining a configuration of the radio subnetwork depending on an intersection of at least two of the body shapes, wherein the configuration of the radio subnetwork comprises features of the radio subnetwork, configuring the radio subnetwork according to the configuration of the radio subnetwork. The intersection of body shapes corresponds to an interference of the radio subnetworks provided by the entities that are associated with the respective body shapes. The method provides framework for configuring the radio subnetwork of at least one of the entities that is associated with a body shape that is in an intersection with a body shape of another entity.

In particular, the entities may be physical entities, e.g. a vehicle. In embodiments, the entities may also comprise or correspond to digital entities, which are preferably assigned to physical entities. The digital entities thus particularly have physical entities in the real world and interact in controlled or non-controlled environments. In particular, the digital entities can be digital twins of the physical entities. The body shapes can be attached to or part of the digital entities, in particular the digital twins. In particular, the body shapes can be virtual body shapes of the physical entities, particularly associated with or part of the digital entities, e.g. of the digital twins.

The method may comprise scaling the body shape for an entity of the entities depending on at least one feature of the radio subnetwork provided by the entity. The interference of the radio subnetworks may depend on a reach of the respective radio subnetworks. The framework comprising the scaling allows adjusting to the reach.

For example, a feature of an entity of the entities comprises a position or orientation of the entity, a coverage or intensity of a subnetwork provided by the entity, a scope of a sensor provided by the entity, or safety limits of the radio subnetwork or the sensor.

For example the radio subnetwork requirements comprise security requirements, available resources, required capabilities of the subnetwork, or sufficient proximity to ensure coverage.

The at least one feature may define a type of the body shape. The framework comprising the type of the body shape allows adjusting to volumetric radio subnetwork properties.

At least one feature may define an intensity of the radio subnetwork, and wherein the scale is determined depending on the intensity. This allows adjusting to the intensity.

Preferably, one or more features may define multiple body shapes each, in particular multiple shapes of the same form but different size or scale. When body shapes of two entities intersect, the configuration or a change in a configuration preferably depends on which scale of the body shape intersects with the other body shape.

An intersection of the body shapes attached to different entities preferably triggers an event. A nature and/or a consequence of such an event preferably depends on the body shapes and/or the features, on which the body shapes depend, and preferably on which scales of the body shapes are intersecting. The body shapes, which can have various, in particular complex forms and can vary in size according to the entities or attributes they represent, thus preferably act as logical triggers. Leveraging (sub) networks' capabilities, these intersections can preferably intelligently orchestrate communication resources and functionalities.

The body shapes may be visualized.

The body shapes may be visualized color coded.

The method may comprise detecting an event, and triggering determining the configuration of the radio subnetwork upon detecting the event.

The method may comprise determining different configurations for different subnetworks that different entities provide, and configuring the subnetworks that the different entices provide with features according to the different configurations.

The device for configuring a radio subnetwork is configured to execute the method.

A computer program may be provided, wherein the computer program comprises computer readable instructions that, when executed by a computer, cause the computer to execute the method.

### BRIEF DESCRIPTION OF THE DRAWINGS

Further advantageous embodiments are derived from the following description and the drawing. In the drawing:

FIG. 1 schematically depicts a first example for a regular body shape for a digital entity,

FIG. 2 schematically depicts a second example for a regular body shape for a digital entity,

FIG. 3 schematically depicts a first example for an irregular body shape for a digital entity,

FIG. 4 schematically depicts a second example for an irregular body shape for a digital entity,

FIG. 5 schematically depicts an irregular body shape in different scales for a digital entity,

FIG. 6 schematically depicts irregular body shapes for different digital entities and in different scopes,

FIG. 7 schematically depicts a simple intersection between body shapes of different digital entities,

FIG. 8 schematically depicts different combinations of intersections between the body shapes of the different digital entities,

FIG. 9 schematically depicts a work flow diagram for defining a subnetwork configuration using digital body shapes and metadata,

FIG. 10 schematically depicts intersections between different digital entities and different combinations of intersections between the body shapes of different digital entities,

FIG. 11 depicts a block diagram including conditions for subnetwork configuration,

FIG. 12 depicts a device for configuring a radio subnetwork.

### DETAILED DESCRIPTION

Dynamic configuration of features of a radio subnetwork in mobility and production situations occurs inside highly complex environments. These environments could be controlled and non-controlled.

An example for a controlled environment is a factory. In the factory, the ambient conditions, the production layout as well as the configurations of static entities and dynamic entities are settled. Even the human factor is in some manner controlled in the factory, since only workers and allowed personnel can appear as entities in the factory.

An example for a non-controlled environment is a mobility environment. The mobility environment comprises non-controlled factors. An example for non-controlled factors are entities, e.g., vehicles and humans, that move inside the mobility environment driven by own decisions and independent control systems.

An example for non-controlled factors are environment factors, like the weather, the infrastructure state, and non-foreseeable events or accidents.

Mobility environments may consider heterogeneous entities, like autonomous vehicles parallel to non-autonomous vehicles, bikes, public transport, pedestrians and more.

A real world scenario describes the environment, the entities, and the mobility or production situation in the environment.

To achieve an efficient feature configuration, several and different real world scenarios are modelled and/or simulated.

An efficient feature configuration is determined based on a result of modeling and/or simulating the different real world scenarios.

Modeling the real world scenarios allows to create adequate feature configurations and to evaluate their performance in advance.

Some examples of aspects for modeling the real world scenarios are geometries of entities, material characteristics of entities, functionalities of entities, and energy consumption of entities. Some examples of aspects for modeling the real world scenarios are environment aspects, e.g., road materials, infrastructure conditions, weather conditions, temporal alerts of traffic, accidents, and roadblocks.

Thus, the simulation based on these real world scenarios can allow to predict and improve future configurations. The simulation based on these real world scenarios minimizes the computing required in real-time and increases configuration efficiency.

To dynamically configurate features in an efficient way, it is required to collect, process, and transmit real-time data from sensor fusion and other multiple decentralized sources. In order to set the right parameters and allocate components in an optimal way, it is necessary to collect and select the right data, with the right format and the right granularity but at the same time, keep a holistic approach considering a big amount of parameters and variables. Therefore, a transparent monitoring is applied that allows for an adequate subnetwork management of a subnetwork of the radio subnetwork and to reduce potential risk of failures.

Additionally, for the optimal decision on the parameters to be configured in the mentioned environments, supporting simulation tools are used for the simulation of the real world scenarios.

In this regard, a digital twin of a real world entity, i.e., the digital entity, supports the planning, controlling and monitoring of feature configuration.

Decision-making for feature configuration can be performed by a user or by algorithms. The user or the algorithm will act as a decision-maker, setting the specific requirements for the feature configuration.

For example, the digital entity comprises a visual interface for decision making by the user.

The digital entity may comprise predicted, real-time and historical feature configurations, as well as proposed feature configurations for evaluating their performance.

Body shapes are attached to digital entities. The digital entities have physical entities in the real world and interact in controlled or non-controlled environments.

The body shapes are generated. The generated body shapes can be, for example, a regular shapes like a sphere or a cylinder but also a very irregular shapes.

The body shape that is generated for a digital entity for example depends on the behavior of the entity. The body shape that is generated for a digital entity for example depends on subnetwork parameters to be analyzed.

Besides the shape, the body can be also scaled to determine different characteristics of a scope of the subnetwork. The scope for example is defined for example by an intensity of the subnetwork or a safety feature.

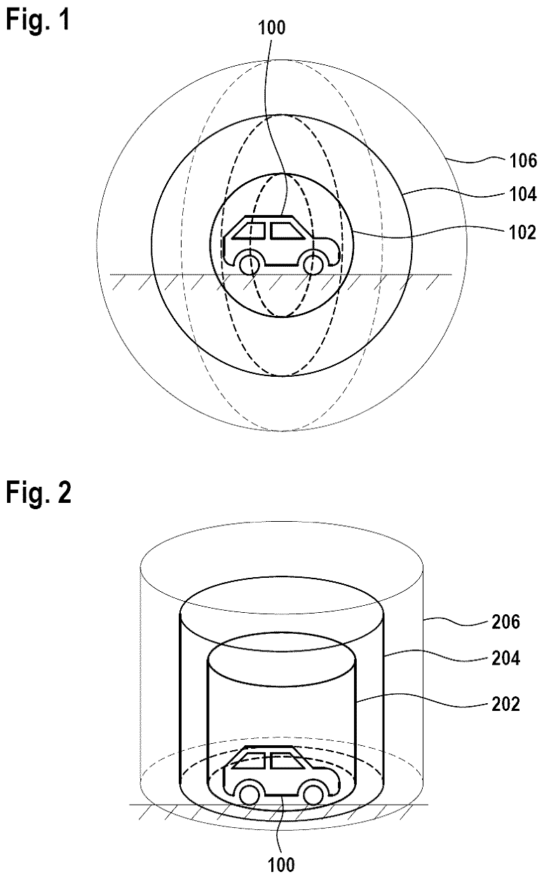

FIG. 1 schematically depicts a first example for a regular body shape for a digital entity 100. The digital entity 100 is a vehicle. According to the first example for the regular body shape, the shape is a sphere. FIG. 1 schematically depicts the spherical shape in different scales. FIG. 1 schematically depicts a first sphere 102, a second sphere 104, and a third sphere 106. The first sphere 102 is smaller than the second sphere 104. The second sphere 104 is smaller than the third sphere 106.

FIG. 2 schematically depicts a second example for a regular body shape for the digital entity 100. According to the second example for the regular body shape, the shape is a cylinder. FIG. 2 schematically depicts the cylindrical shape in different scales. FIG. 2 schematically depicts a first cylinder 202, a second cylinder 204, and a third cylinder 206. The first cylinder 202 is smaller than the second cylinder 204. The second cylinder 204 is smaller than the third cylinder 206.

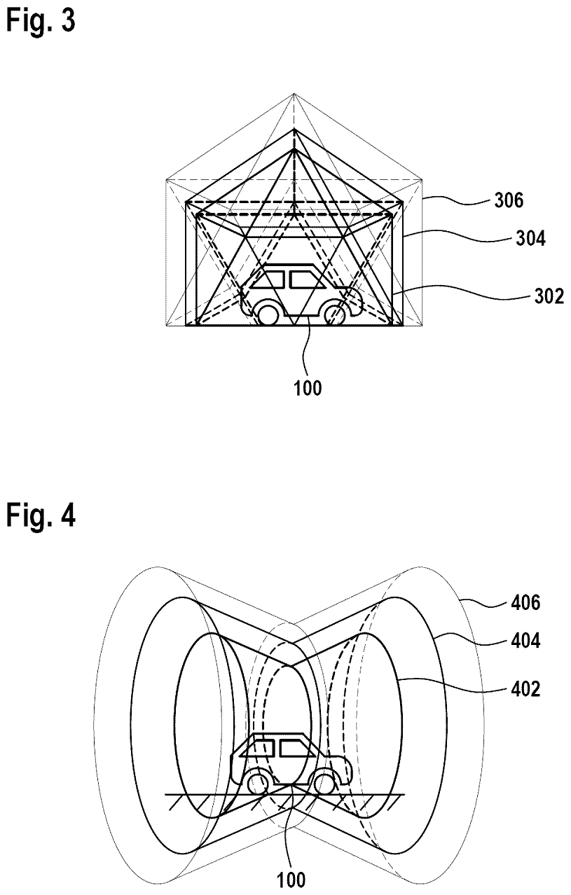

FIG. 3 schematically depicts a first example for an irregular body shape for the digital entity 100. According to the first example for the irregular body shape, the shape is a house shaped pentagon. FIG. 3 schematically depicts the house shaped pentagon shape in different scales. FIG. 3 schematically depicts a first house shaped pentagon 302, a second house shaped pentagon 304, and a third house shaped pentagon 306. The first house shaped pentagon 302 is smaller than the second house shaped pentagon 304. The second house shaped pentagon 304 is smaller than the third house shaped pentagon 306.

FIG. 4 schematically depicts a second example for an irregular body shape for the digital entity 100. According to the second example for the irregular body shape, the shape is a waisted cylinder. FIG. 4 schematically depicts the waisted cylinder shape in different scales. FIG. 4 schematically depicts a first waisted cylinder 402, a second waisted cylinder 404, and a third waisted cylinder 406. The first waisted cylinder 402 is smaller than the second waisted cylinder 404. The second waisted cylinder 404 is smaller than the third waisted cylinder 406.

Metadata describes the body shape of the digital entity 100. The metadata comprises concrete features and scopes of the subnetwork, like a dipole radiation pattern, signal strength, wireless network speed, sensing range or functional safety limits, depending on their shapes and their scales.

The body shapes of different entities may trigger an intersection of the shapes representing the entities, in particular when the entities are moving relatively to each other.

If the body shapes trigger an intersection, several conditions are reviewed and the configuration of the features of the subnetworks provided by the entities that trigger the intersection will be managed based on the intersection.

The different entities may trigger the intersection of the shapes of different scale which in turn may trigger events for a configuration or reconfiguration of the radio subnetworks of the entities.

A configurable feature defines a characteristic of the subnetwork in a volumetric body. The configurable feature defines the shape of the volumetric body. The scale defines the size of the volumetric body.

This means, the shape and the size of the volumetric body depend on the characteristics of the feature that is represented by the volumetric body.

Very irregular shapes may be used to ensure accuracy of the representation of the feature by the volumetric body.

However, if the requirements of the application do not need high accuracy, the irregular shape that would be required for best accuracy may be simplified, e.g. using a simpler irregular shape or a regular shape. This reduces the computing resources required.

Although it would be expected that the same feature would be modeled with the same shape, it is possible to add to the same entity as many volumetric bodies as necessary, not only to represent different features, but also different ranges of the same feature with the same shape but different size, or even different behaviors of the same feature under certain conditions using another shape. An example for using different volumetric bodies is the transmission of an antenna signal emitted before and after polarization.

Using the potential of the integration of the digital twin in a physics engine, it is possible to create and visualize body shapes with intrinsic information.

The digital twin, i.e. the digital entity, is a digital representation of a real world physical entity. This means, the entities are interconnected and interdependent. This means that whatever happens in the digital entity happens in the real world physical entity. This means that whatever happens in the real world physical entity happens in the digital entity.

For this purpose, digital twins are implemented as a highly complex description of assets and their semantic relationships, which should behave exactly as the entity they represent behaves in the physical world and get continuous feedback from the corresponding physical entities.

The continuous responsive feedback from the physical entities only allows for a reactive and delayed digital representations. To mirror the real behavior of the physical entities in the digital world, the digital twins may use physics engines, predictive simulations, and/or real-time simulations to improve the active twinning of the physical entities.

For example, an accurate physics model is created to represent the physical world. The physics model may use a physics environment, e.g., a game engine, to accurately model physics of the physical world.

An example for a physics model is a model of a production line including conveyor belts, robots, machines and workers.

An example for a physics model is a model of some city blocks with its streets, buildings, tunnels, trees, vehicles, public transport, pedestrians, the weather, and/or blocked routes.

The physics model is a digital physics model that behaves according to the physics space-temporal rules including mechanic and material parameters. Other simulation tools may be used to feed the physics model with the metadata.

The radio subnetworks are configured based on the body shapes that are generated for and attached to the digital entities.

These digital entities have physical entities in the real world and therefore, the proposed body shapes represent a geometry spectrum, in which certain configurable features of the radio subnetworks of a system of radio subnetworks provided by the entities are defined and valued.

It is assumed that the relevant configurable features and the requirements for configuring the configurable features are already known.

These configurable features are used to manage and to improve the system performance, for example to manage subnetwork configurations or to determine safety areas for collaborative driving of vehicles.

In collaborative driving, the generated body shapes may represent the scope of different in-vehicle sensors. Physically, a body shape will be a volume with a transparent material, meaning no physical collision but a logical trigger showing intersections with other body shapes or also intersections with other digital-physical entities.

The amount of heterogeneous variables in controlled and non-controlled environments, such as production systems and vehicular mobility systems, is massive, so the monitoring and control of such systems has a high inherent and perceived complexity. Hence, the proposed body shapes can help to increase transparency during the monitoring and during simulations through graphical and tridimensional visualization of the configurable features.

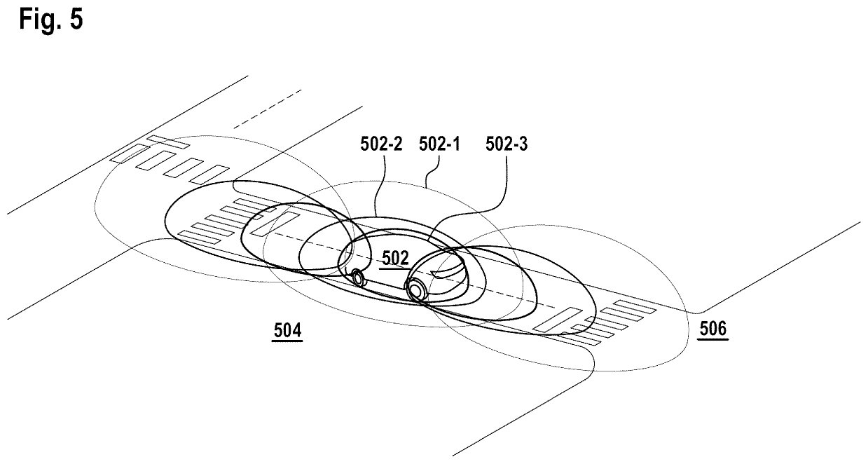

FIG. 5 schematically depicts an irregular body shape in different scales 502-1, 502-2, 502-3 for a digital entity 502. The digital entity 502 is a digital twin of a real world vehicle. FIG. 5 also depicts a digital representation 504 of a real world infrastructure in which the digital entity 502 moves. The digital representation 504 of the infrastructure comprises a digital representation 506 of a road, on which the vehicle moves in the real world.

In a visualization of the body shape in the different scales 502-1, 502-2, 502-3 the body shapes can be denotated by using different colors with a transparent shader, so that the visualization of the body shapes doesn't limit the visualization of the digital entity 502 and the digital representation 504 of the environment and the digital representation 506 of the road.

Furthermore, the body shapes of different digital entities may be highlighted using different colors.

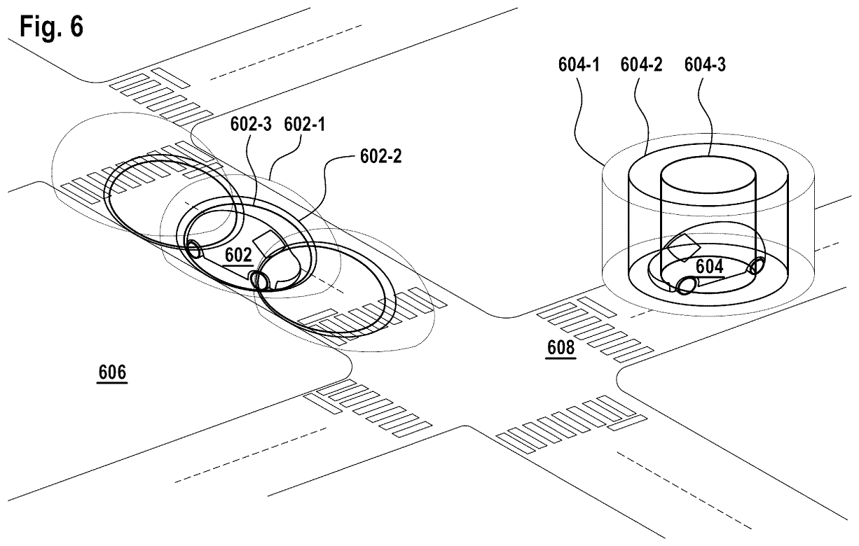

FIG. 6 schematically depicts an example of the visualization of different digital entities and irregular body shapes in different scales for the different digital entities. By way of example, a first digital entity 602 and a second digital entity 604 are depicted in a digital representation 606 of a real world infrastructure. The irregular body shape of the first digital entity 602 is depicted in different shapes 602-1, 602-2, 602-3. The irregular body shape of the second digital entity 604 is depicted in different shapes 604-1, 604-2, 604-3.

To check intersections of body shapes of digital entities, the body shapes are preferably provided with events. An event doesn't limit the physical behavior of the digital entity associated with the body shape.

This means, the entities don't collide physically but the intersection of the body shape of one digital entity with the body shape of another digital entity triggers the event.

In this way, two or more body shapes of different entities can intersect with each other, allowing high complex combinations of events to manage the configurable features.

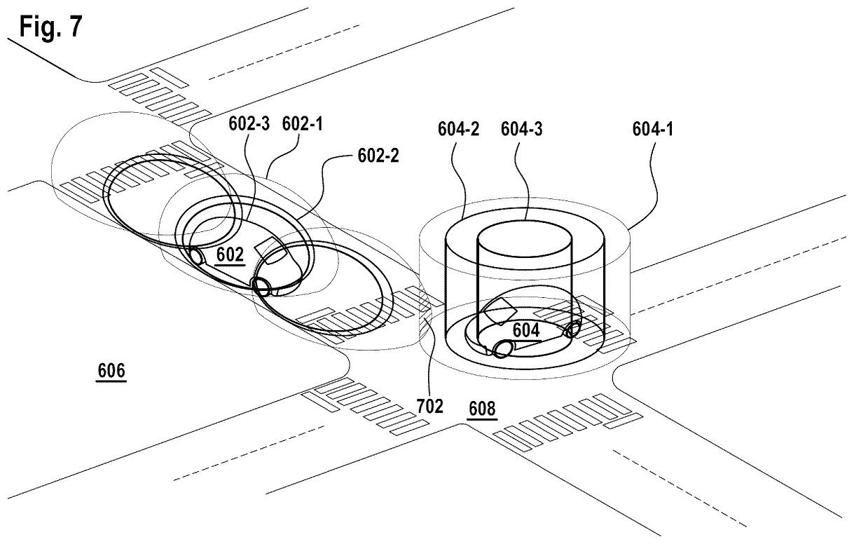

FIG. 7 schematically depicts a simple intersection 702 between body shapes of different digital entities. FIG. 7 schematically depicts the intersection 702 of the largest scale 602-1 of the body shape of the first digital entity 602 with the largest scale 604-1 of the body shape of the second digital entity 604.

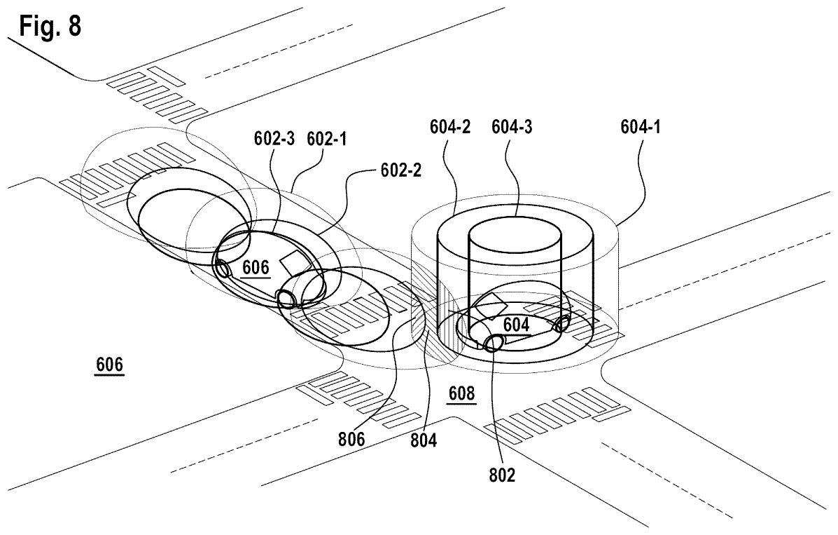

FIG. 8 schematically depicts different combinations of intersections between the body shapes of the different digital entities.

FIG. 8 schematically depicts a first intersection 802 of the largest scale 602-1 of the body shape of the first digital entity 602 with the middle scale 604-2 of the body shape of the second digital entity 604. FIG. 8 schematically depicts a second intersection 804 of the largest scale 602-1 of the body shape of the first digital entity 602 with the largest scale 604-2 of the body shape of the second digital entity 604. FIG. 8 schematically depicts a third intersection 806 of the middle scale 602-2 of the body shape of the first digital entity 602 with the largest scale 604-1 of the body shape of the second digital entity 604. The consequence of the intersection, in particular a triggering of a reconfiguration, preferably depends on which scale of multiple scales of a body shape is intersected. In particular, an intersection of a body shape, e.g. associated with a safety feature, with multiple scales can cause an escalating configuring or reconfiguring.

According to the example for collaborative driving, an existing digital twin is assumed that represents the vehicle and the location of the vehicle, e.g., the position and orientation of the vehicle.

However, the same methodology using different body shapes of different scales to represent radio subnetworks can be implemented also for much more complex digital twins without restriction.

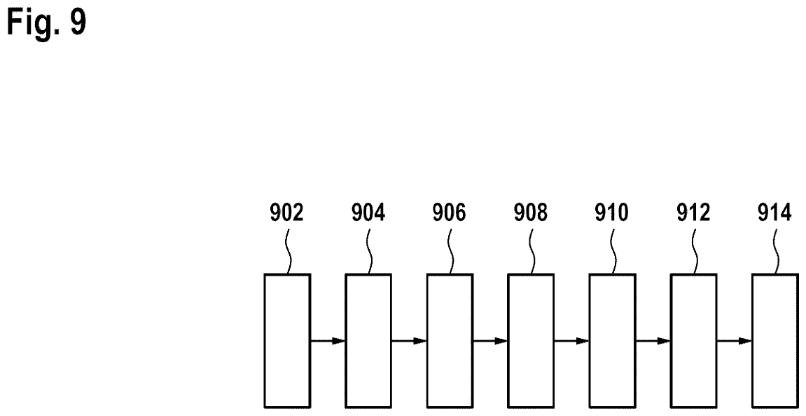

FIG. 9 schematically depicts a workflow diagram for defining a subnetwork configuration using digital body shapes. The workflow provides a method for configuring the radio subnetworks provided by real world entities and simulated by the digital entities.

The workflow comprises a step 902.

The step 902 comprises determining a configuration of the radio subnetworks.

The configuration comprises features of the radio subnetworks.

An example for a feature is the position and orientation of an entity of the entities. The entity provides a radio subnetwork of the radio subnetworks. The entity may have different and more complex features.

The features of the entities may comprise coverage or intensity of the radio subnetwork provided by the respective entity, scope of a sensor provided by the respective entity, or safety limits of the radio subnetwork or the sensor provided by the respective entity.

The workflow comprises a step 904.

The step 904 comprises determining radio subnetwork requirements.

The subnetwork requirements comprise, for example, security requirements, available resources, required capabilities of the subnetwork and also sufficient proximity to ensure coverage.

At least one requirement is provided for at least one radio subnetwork of the radio subnetworks.

The workflow comprises a step 906.

The step 906 comprises selecting adequate body shapes for the digital entities.

According to an example, the digital entity's features that are relevant to achieve the radio subnetwork requirements will determine the type of shape that the volumetric bodies associated with the digital entity have. For example, digital entity's features that are irrelevant to achieve the radio subnetwork requirements are ignored when determining the type of shape.

The features that are relevant to the configuration are determined depending on the radio subnetwork requirements. For example, the features that provide the security requirements, the available resources, the required capabilities of the radio subnetwork and the sufficient proximity to ensure coverage are selected from the digital entity's features.

For the selection of the appropriate shape an analysis of the feature represented by the shape may be carried out. This analysis may be carried out manually by an analyst or may be implemented through AI-based technologies.

The shape of the feature to be represented by the volumetric body may also be part of the inherent information that the digital entity previously contains and shares when the digital entity enters the system and is registered in a digital twin of the system.

For example, for the implementation, a correspondent digital body shape containing physically traversable colliders is created. The body shape may be represented as a visualization of a non-physical and transparent material using different colors for the body shapes associated with different digital entities in the visualization.

The workflow comprises a step 908.

The step 908 comprises scaling the body shapes.

The body shapes may be modeled in different scales depending on the feature represented by the shape.

For example, the feature is a feature of the radio subnetwork provided by the respective entity.

For example, the feature is the intensity of the radio subnetwork provided by the respective entity.

The intensity of the radio subnetwork is more intense if measured at a distance close to the respective entity. This may be represented by a small volumetric body close to the respective digital entity.

The intensity of the radio subnetwork still possesses some intensity in a distance larger than the distance close to the respective entity. This may be represented by a volumetric body that is larger than the small volumetric body.

For example, the feature is a safety distance.

The safety distance bears a larger risk if the safety distance is small. This may be represented by a small volumetric body close to the respective digital entity.

The safety distance still possesses some risk if the safety distance is larger than the small distance. This may be represented by a volumetric body that is larger than the small volumetric body.

The workflow comprises a step 910.

The step 910 comprises visualizing the body shapes. The body shapes may be visualized color coded.

Visualization is a big advantage because visualizing allows a transparent monitoring of the system and the versatility of allowing an artificial system or a human to decide about the most optimal radio subnetwork configuration. Visualization also allows to observe dynamically the radio subnetwork allocation and configuration and detect failures or possible improvements

The workflow comprises a step 912.

The step 912 comprises determining a re-configuration of the subnetworks provided by the entities. The step 912 comprises determining the features that define the re-configuration of the subnetworks.

The re-configuration of the subnetworks comprises a respective configuration for the radio subnetwork provided by the respective entities. The re-configuration may comprise a re-configuration for the radio subnetwork provided by at least one of the entities. The re-configuration may comprise an unchanged configuration for at least one of the radio subnetworks.

The step 912 may comprises detecting an event, that triggers determining the re-configuration.

The event may be an intersection of body shapes of different digital entities. The body shapes may intersect in various ways. The multiple intersections of different body shapes are detected as different events. Different events may result in different re-configurations of the features.

For example, an intersection triggers one or more of the following events:

Context—Aware Bandwidth Allocation: As two entities approach within a defined body shape, in particular if body shapes of two entities intersect, the (sub) network dynamically allocates higher bandwidth to support real-time, low-latency applications needed for their interaction. Think augmented reality overlays in a shared workspace or ultra-reliable, low-latency communication (URLLC) links for critical machine-to-machine collaboration.

Network Slicing Optimization: The intersection triggers an activation of a dedicated network slice optimized for a specific task. E.g. if two autonomous vehicles are approaching a merging point, a dedicated slice with enhanced safety features (URLLC) could be activated to ensure collision avoidance. Conversely, when two IoT devices simply need to exchange background data, they might be relegated to a less resource-intensive slice.

Edge Computing Offloading: When body shapes intersect near a mobile edge computing server, the computation-heavy tasks necessary for their collaboration can be offloaded to the edge. E.g. if two robots are sharing a complex AI model for object recognition, then processing is moved to the edge computing server for faster and more efficient operation.

Trusted Data Exchange and Authentication: As body shapes intersect, the system can initiate secure authentication protocols and establish trusted data exchange channels using (sub) network's enhanced security features. This would be essential for secure transactions or confidential data sharing between devices.

The workflow comprises a step 914.

The step 914 comprises configuring the subnetworks according to the re-configuration.

The configuration may be changed dynamically by adjusting the features in real-time.

The step 914 may comprises configuring the entities that provide the subnetworks according to the re-configuration. Configuring the entities may comprise configuring the digital entities or the real world entities that provide the subnetworks.

The digital twin of the system may provide that configuring the digital entities results in configuring the real world entities they represent as well.

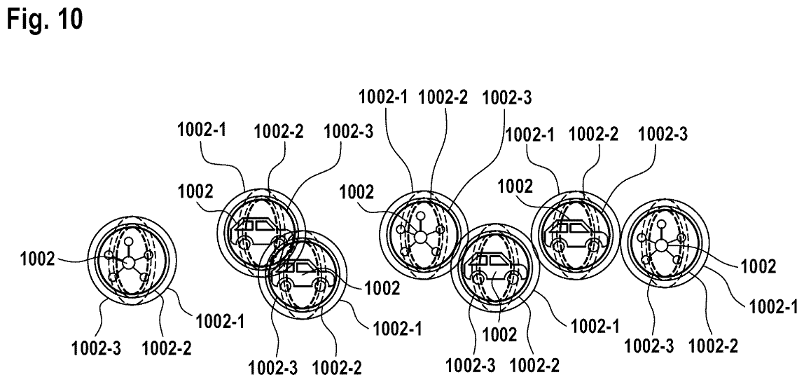

FIG. 10 schematically depicts different intersections between different digital entities 1002 and different combinations of intersections between the body shapes 1002-1, 1002-2, 1002-3 of different digital entities 1002.

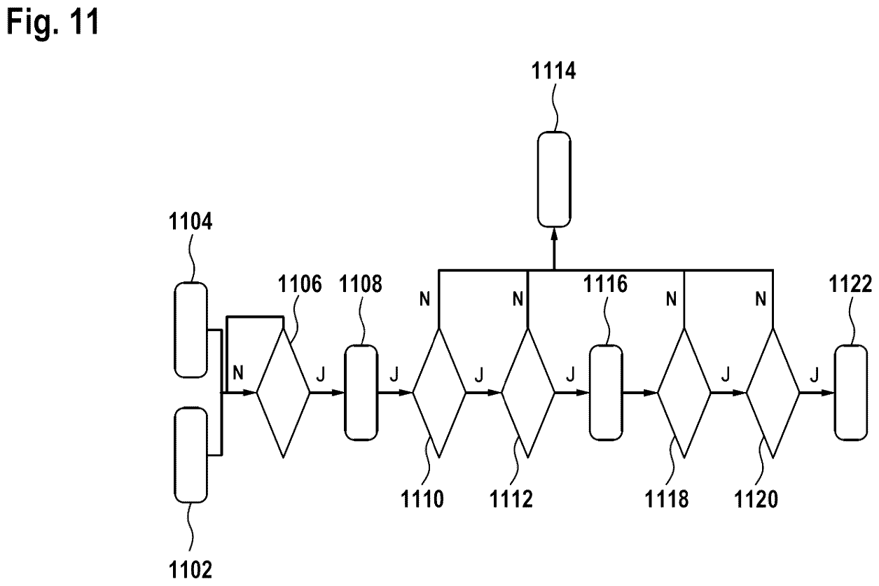

FIG. 11 depicts a block diagram including different conditions for subnetwork configuration. The different conditions correspond to different events.

The different conditions are described by way of an example of a first entity 1102 and a second entity 1104. According to an example, the first entity 1102 is a mobile device. According to an example, the second entity 1104 is a subnetwork node.

In a step 1106, it is determined whether event is detected. The event may be an intersection between a body shape associated with the first entity 1102 and a body shape associated with the second entity 1104.

A step 1108 is executed, in case the event is detected. Otherwise the step 1106 is executed.

In the step 1108 the body shapes of the first entity 1102 and the second entity 1104 that intersect are identified.

Afterwards a step 1110 is executed.

In the step 1110 it is determined whether the second entity 1104 is close enough to the first entity 1102 to ensure radio coverage with the radio subnetwork that the second entity 1104 provides or not.

A step 1112 is executed, when the second entity 1104 is close enough to the first entity 1102 to ensure radio coverage with the radio subnetwork that the second entity 1104 provides. Otherwise a step 1114 is executed.

In the step 1112, it is determined whether the radio subnetwork that the second entity 1104 provides has enough resources to ensure radio access with the radio subnetwork that the second entity 1104 provides or not.

A step 1116 is executed, when it is determined that the radio subnetwork that the second entity 1104 provides has enough resources to ensure radio access with the radio subnetwork that the second entity 1104 provides. Otherwise the step 1114 is executed.

The step 1116 comprises an authentication of the first entity 1102 and the second entity 1104.

Afterwards a step 1118 is executed.

In the step 1118 it is determined whether the connection between the first entity 1102 and the second entity 1104 is secure and legal.

A step 1120 is executed in case the connection between the first entity 1102 and the second entity 1104 is secure and legal, a step 1122 is executed. Otherwise, the step 1114 is executed.

In the step 1120, it is determined whether subnetwork that the second entity 1104 provides meets the requirement of the first entity 1102 or of a task that the first entity 1102 wants to execute. An example for the requirement is a maximum latency allowed.

A step 1122 is executed in case the subnetwork that the second entity 1104 provides meets the requirement. Otherwise the step 1114 is executed.

In the step 1122, the first entity 1102 enters the subnetwork of the second entity 1104.

In the step 1114, the first entity 1102 keeps providing the subnetwork that the first entity 1102 provides. The step 1114 may comprise looking for a subnetwork provided by another entity.

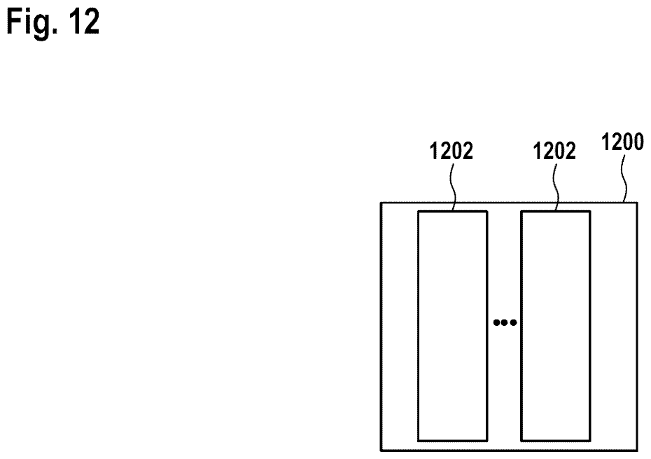

FIG. 12 schematically depicts a device 1200 for configuring radio subnetworks 1202. The radio subnetworks 1202 are provided by entities in the real world. The device 1200 is configured to execute the workflow.

1. A method for configuring a radio subnetwork of radio subnetworks provided by entities, wherein the method comprises determining (902) a configuration of the radio subnetwork, wherein the configuration comprises features of the radio subnetworks, determining (904) at least one requirement of at least one of the radio subnetworks, determining (906) body shapes for the entities depending on at least one feature, wherein the at least one feature is selected from the configuration depending on the at least one requirement, determining (912) a configuration of the radio subnetwork depending on an intersection of at least two of the body shapes, wherein the configuration of the radio subnetwork comprises features of the radio subnetwork, configuring (914) the radio subnetwork according to the configuration of the radio subnetwork.

2. The method according to claim 1, wherein the method comprises scaling (908) the body shape for an entity of the entities depending on at least one feature of the radio subnetwork provided by the entity.

3. The method according to claim 1, wherein a feature of an entity of the entities comprises (902) a position or orientation of the entity, a coverage or intensity of a subnetwork provided by the entity, a scope of a sensor provided by the entity, or safety limits of the radio subnetwork or the sensor.

4. The method according to claim 1, wherein the radio subnetwork requirements comprise (904) security requirements, available resources, required capabilities of the subnetwork, or sufficient proximity to ensure coverage.

5. The method according to claim 1, wherein the at least one feature defines (906) a type of the body shape.

6. The method according to claim 1, wherein at least one feature defines an intensity of the radio subnetwork, and wherein the scale is determined (908) depending on the intensity.

7. The method according to claim 1, wherein the body shapes are visualized (910).

8. The method according to claim 7, wherein the body shapes are visualized (910) color coded.

9. The method according to claim 1, wherein the method comprises detecting (912) an event, and triggering determining the configuration of the radio subnetwork upon detecting the event.

10. The method according to claim 1, wherein the method comprises determining different configurations for different subnetworks (1202) that different entities provide, and configuring the subnetworks (1202) that the different entities provide with features according to the different configurations.

11. A device (1200) for configuring a radio subnetwork (1202), wherein the device (1200) is configured to execute the method according to claim 1.

12. A non-transitory, computer-readable medium containing instructions that, when executed by a computer, cause the computer to execute the method according to claim 1.
